(19) United States
(12) Patent Application Publication
(10) Pub. No.: US 2018/0107813 A1
(43) Pub. Date: Apr. 19, 2018

(54) User Authentication Persistence

(71) Applicant: Plantronics, Inc., Santa Cruz, CA (US)

(72) Inventor: Erik Perotti, Santa Cruz, CA (US)

(73) Assignee: Plantronics, Inc., Santa Cruz, CA (US)

(21) Appl. No.: 15/296,674

(22) Filed: Oct. 18, 2016

(51) Int. Cl. G06F 21/32

(52) U.S. Cl. CPC G06F 21/32

(57) ABSTRACT

Methods and apparatuses for user authentication are described. In one example, an active condition of an authenticator device is detected and the identity of the user is authenticated. A biometric input is received to enter an authenticated state. The authenticated state is maintained if the authenticator device has not shifted from the active condition to an inactive condition. An authentication request is received while the authenticator device is in the authenticated state. An authentication success is reported to the authentication requestor device.

### BACKGROUND OF THE INVENTION

User authentication can be understood to be the act of proving to a computer-based system that a user is who she or he claims to be (i.e., authentication of the identity of the user). User authentication is often described in terms of something-you-know (e.g., a password), something-you-have (e.g., an ATM card), or something-you-are (e.g., fingerprint). User authentication is the process of verifying one or more of these factors.

For example, a typical computer user is required to authenticate himself for a wide variety of purposes, such as logging in to a computer account, retrieving e-mail from servers, accessing certain files, databases, networks, web sites, etc. In banking applications, a bank account holder is required to enter a personal identification number (PIN) in order to access an automated teller machine (ATM) to conduct a banking transaction.

One problem to be solved is authenticating in a convenient and secure way. Many systems for user authentication are available although none are completely satisfactory. For example, existing authentication solutions typically have a user type a password or personal identification number (PIN), also called credentials.

Using passwords is both tedious and often not very secure. For example, others can see or overhear passwords. A major problem is remembering multiple passwords and users are forced either to use the same password for all authentication systems (not secure) or forever recover/reset passwords as they become forgotten. Users may choose very simple, easily ascertained passwords. If a more difficult password is chosen, the user may write the password down, making it subject to theft. Broadly speaking, there is a continuum with passwords—those that are easy to remember and those that that are obscure, making them harder to guess. To date, authenticators have been singular. You have a password. You lose it, you need a new one.

Biometrics such as fingerprints, retinal scans, and voice characteristics can also be used to help uniquely identify an individual. However, biometric input and authentication can be inconvenient and time consuming for users. Furthermore, because there are often several layers of security in today's complex systems, users may be required to submit to multiple authentication procedures to perform a single task. For example, in today's mobile environment, people often use smartphone mobile applications (referred to as “apps”) to perform a variety of tasks. Some smartphone apps do not require authentication after unlocking of the phone (e.g., gaming apps) while there are other apps that require an additional authentication step, e.g., banking or investing apps. Currently, when a user wants to access a smartphone app that requires authentication, the user is required to authenticate firstly to the smartphone (e.g., with a fingerprint) to unlock it, then launch the app (e.g., the banking app) and then authenticate again, for example by again providing the fingerprint. The banking app does not trust the initial provision of the fingerprint to unlock the phone, even though it is the phone itself that manages the second comparison and the authentication on behalf of the banking app. That is, the user is required to perform redundant authentication, one after another in quick succession, both to the phone. This redundant authentication is viewed by users as inconvenient and unnecessary.

As a result, improved methods and apparatuses for user authentication are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for user authentication in one example.

FIG. 2 illustrates a simplified block diagram of the authenticator shown in FIG. 1.

FIG. 3 illustrates an illustration of a data structure at the authenticator shown in FIG. 2 storing biometric authentication data.

FIG. 4 illustrates a process for persistent user authentication in one example.

FIG. 5 is a flow diagram illustrating a process for persistent user authentication in a further example.

FIGS. 6A-6C are a flow diagram illustrating a process for user authentication in a further example.

FIGS. 7A-7B are a flow diagram illustrating a process for user authentication in a further example.

FIG. 8 is a flow diagram illustrating a process for user authentication in a further example.

### DESCRIPTION OF SPECIFIC EMBODIMENTS

Methods and apparatuses for user authentication are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments unless otherwise noted.

In prior art systems, when a user wants to authenticate an application, payment transaction or similar, she often has to perform multiple authentications. The inventor has recognized the use of multiple authentications is redundant in circumstances where there is trust that a prior authentication need not be destroyed and can be used in subsequent authentications. In one example embodiment, a headset in in a donned status on the user head. As long as this status is maintained after the initial authentication, the authentication is valid. In this case, when further applications require authentication, the headset does not ask the user for a voiceprint but merely responds to the phone (the authentication requestor) that the user is authenticated. If the appropriate response is a voiceprint, the headset can provide the voiceprint that was provided previously, formatted appropriately with a required timestamp and any encryption if needed. The headset does not have to capture a fresh voiceprint each time because the original voiceprint is still valid because the headset is still donned. The headset can also use additional factors to ensure that the don status is still valid, for example by checking continued headset motion when worn and verifying that proximity has stayed “near.”

In one example embodiment, methods and apparatuses described herein are used in a Fast Identity Online (FIDO) challenge-response implementation. Two-factor authentication as contemplated by the FIDO alliance includes a challenge-and-response after authentication, as a final confirmation that a real person is there to receive and respond. In one authentication implementation, the something-you-have authentication factor is provided by a FIDO-compliant USB security dongle that is uniquely assigned to the user. The something-you-are authentication factor can be satisfied for example by a biometric authenticator like a fingerprint reader on the laptop keypad. When the user of a laptop wants to log in to a FIDO-compliant website, the user-specific FIDO dongle, which is plugged into the laptop, is queried and checked against the user record. The user's fingerprint is also checked by the fingerprint reader on the laptop, thereby establishing two-factor authentication. As a final step, to ensure that a person is present at the laptop, the webpage will ask a challenge question, for example: “Do you want to view your bank account? If yes, press the button on the dongle.” At which point the user responds to the challenge by pressing the physical button on the dongle. This challenge-response establishes the “presence” of a human being at the laptop, although it in itself is not truly a third authentication. In the case of a FIDO challenge-response implementation, the inventive headset will respond with “button pressed” without having to ask the user for a button press. This is in addition to responding with confirmation of (continued) authentication as in the previous example.

Advantageously, implementation of persistent authentication based on continued DON status is that it can integrate into existing authentication protocols without requiring any modification or update to the device OS or mobile apps. In further examples, the smart phone persists authentication based on continued headset donned status. Furthermore, advantageously the user authentication methods and systems described provide faster authentication response times and less user interaction by eliminating unnecessary redundant authentication.

In one example embodiment, a method for authenticating an identity of a user includes detecting an active condition of an authenticator device, and authenticating an identity of the user during the active condition. Authenticating the identity of the user includes receiving a biometric input at the authenticator device to enter an authenticated state at the authenticator device. The method includes maintaining the authenticated state if the authenticator device has not shifted from the active condition to an inactive condition subsequent to detecting the active condition and authenticating the identity of the user. The method further includes receiving at the authenticator device from an authentication requestor device a request to authenticate a user, the request received while the authenticator device is in the authenticated state. The method further includes reporting an authentication success to the authentication requestor device if the authenticator device is in the authenticated state, where the authenticated state was entered following authenticating the identity of the user prior to receiving the request to authenticate the user from the authentication requestor device.

In one example embodiment, a method for authenticating an identity of a user includes receiving at a head-worn authenticator device from an authentication requestor device a first request to authenticate a user. The method includes detecting a donned condition of the head-worn authenticator device on the user and authenticating an identity of the user. Authenticating the identity of the user includes receiving a biometric input at the head-worn device. The method includes reporting a first authentication success to the authentication requestor device.

The method further includes maintaining an authenticated state at the head-worn authenticator device if the usage state of the head-worn authenticator device has not shifted from the donned condition to a doffed condition subsequent to detecting the donned condition of the head-worn authenticator device on the user. The method includes receiving at the head-worn authenticator device from an authentication requestor device during the authenticated state a second request to authenticate a user, and reporting a second authentication success to the authentication requestor device during the authenticated state.

In one example embodiment, a head-worn authenticator device includes a detector providing a detector output indicating a donned condition or doffed condition, a microphone, and a speaker. The head-worn authenticator device includes a wireless communications transceiver operable to receive an authentication request from an authentication requestor device, a processor, and a memory. The memory includes a user biometric data, and an application program including executable instructions. The executable instructions are configured to identify a donned condition of the head-worn authenticator device from the detector output, and authenticate an identity of the user. The identity of the user is authenticated utilizing the user biometric data stored in the memory and a current biometric input at the head-worn device to enter an authenticated state during the donned condition. The authenticated state is maintained if the head-worn authenticator device has not shifted from the donned condition to a doffed condition subsequent to authentication of the identity of the user.

The executable instructions are configured to receive an authentication request to authenticate a user, the request received while the head-worn authenticator device is in the authenticated state. The executable instructions are further configured to report an authentication success to the authentication requestor device utilizing the wireless communication transceiver if the head-worn authenticator device is in the authenticated state, where the authenticated state was entered prior to receiving the request to authenticate the user from the authentication requestor device.

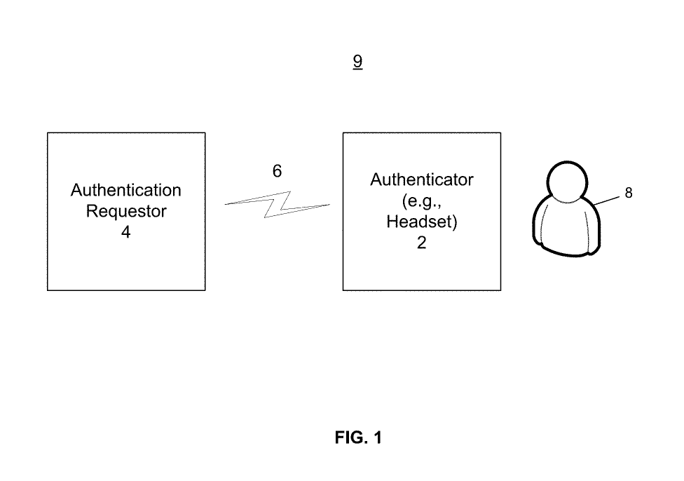

FIG. 1 illustrates a user authentication system 9 according to an embodiment of the present invention. The authentication system 9 includes an authenticator device 2 and an authentication requestor device 4. The authenticator device 2 is configured to authenticate a user and maintain (i.e., persist) an authenticated state as long as it maintains an active condition.

In one example operation of authenticating a user 8, an active condition of an authenticator device 2 is detected. In one example, the active condition is a normal usage of the authenticator device 2 and the inactive condition is non-usage of the authenticator device 2 or some usage outside of the normal usage. For example, the authenticator device 2 is a head-worn device and the active condition is a donned (i.e., worn) condition on a user 8 head and the inactive condition is a doffed (i.e.. removed) condition off the user 8 head. In a further example, the authenticator device 2 is a computing device and the active condition is a carried condition and the inactive condition is a not carried condition (e.g., placed on a surface). What is considered normal usage of the authenticator device 2 is dependent on the type of authenticator device 2 and is pre-defined at the authenticator device 2.

The identity of the user 8 is authenticated during the active condition. For example, the user identity is authenticated by receiving a biometric input at the authenticator device 2 to enter an authenticated state at the authenticator device 2. The authenticated state is maintained if the authenticator device 2 has not shifted from the active condition to an inactive condition subsequent to authenticating the identity of the user 8.

While the authenticator device 2 is in the authenticated state, a request to authenticate a user 8 is received at the authenticator device 2 from an authentication requestor device 4. An authentication success is reported from the authenticator device 2 to the authentication requestor device 4 without the need for the user to re-authenticate. The authenticated state was entered following authenticating the identity of the user 8 prior to receiving the request to authenticate the user 8 from the authentication requestor device 4. An authentication success message is output at the authenticator device 2 following authenticating the identity of the user 8 or reporting an authentication success to authentication requestor device 4.

In a further example operation of authenticating a user 8, a first request to authenticate a user 8 is received at an authenticator device 2 from an authentication requestor device 4. A donned condition of the authenticator device 2 is detected on the user 8. In one example, detecting the donned condition of the authenticator device 2 on the user 8 includes identifying a shift from a doffed condition to the donned condition.

An identity of the user 8 is authenticated by receiving a biometric input at the device. A first authentication success is reported to the authentication requestor device 4. An authenticated state is maintained at the authenticator device 2 if the usage state of the authenticator device 2 has not shifted from the donned condition to a doffed condition.

A second request to authenticate a user 8 is received at the authenticator device 2 from an authentication requestor device 4 during the authenticated state. A second authentication success is reported to the authentication requestor device 4 during the authenticated state. If a shift from the donned condition to a doffed condition is identified, the authenticated state of the head-worn authentication device is responsively terminated and a non-authenticated state is entered.

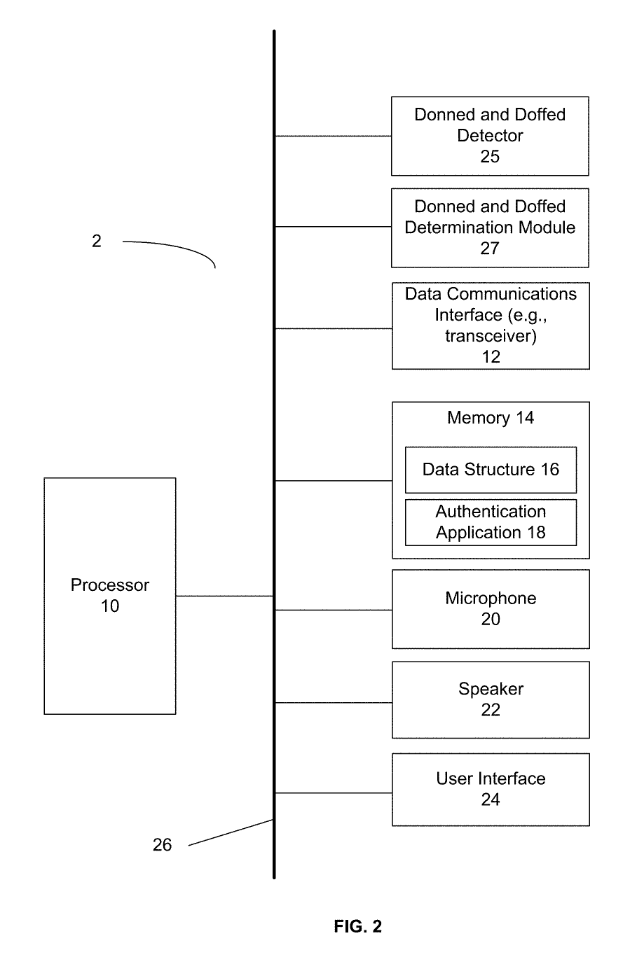

In one example, the authenticator device 2 is advantageously a body worn device such as a headset. In this headset example, the active condition is that it maintains a worn state on the user head (i.e., donned state) on the user head. While the term “headset” has various definitions and connotations, for the purposes of this disclosure, the term is meant to refer to any head-worn device capable of performing operations described herein. The headset may utilize either a single headphone (e.g., a monaural headset) or a pair of headphones (e.g., a binaural headset). In further examples, authenticator device 2 may also be a computing device, cellular phone, a personal heads-up display (HUD) device, or any suitable device for presenting and receiving authentication related information. Authenticator device 2 stores an authentication application as described below in reference to FIG. 2. In one example, the authentication requestor device 4 is advantageously a smartphone. In further examples, authentication requestor device 4 may be any suitable computing device for requesting user authentication.

According to one embodiment of the invention, data communication between the authentication requestor device 4 and the authenticator device 2 is transmitted via a wireless link 6. For example, wireless link 6 is a Bluetooth wireless link, a Wi-Fi (IEEE 802.11) wireless link, a Wi-Max (IEEE 802.16) link, a cellular communications wireless link, or other wireless communications link. In a further embodiment, data communication between the authentication requestor device 4 and the authenticator device 2 is transmitted via a wired link (e.g., a Universal Serial Bus (USB)). In one embodiment, authentication requestor device 4 is any secure computer system which the user 8 wishes to access to perform a desired action. For example, the secure system may be a website such as a financial institution website at which user 8 wishes to access account information or perform a financial transaction. For example, user authentication may be performed at a website, such as logging onto the website at first instance, or to make a purchase at the website.

In one embodiment, data communication between the authentication requestor device 4 and the authenticator device 2 is transmitted via one or more communication networks. For example, the one or more networks may include an Internet Protocol (IP) network, cellular communications network, IEEE 802.11 wireless network, or any combination thereof.

According to operation in an example embodiment, authenticator device 2 stores a one or more authorized user voiceprints in a memory of the authenticator device 2. Each voiceprint is associated with an authorized user. The voiceprint is a statistical model of the user's voice, and is based on acoustic and linguistic properties. In one example, each authorized user and corresponding voiceprint is created during an initial enrollment session. The user provides a voice input (e.g., verbally speaks their name or some other predetermined phrase key). A user voiceprint is constructed, whereby the characteristics of the user's speech are used to build the voiceprint. For example, the voiceprint is a calculated set of numeric parameters which quantify biometric characteristics of the user's voice, such as frequency spectrum, timing, and amplitude. Gaussian mixture models, hidden Markov models, frequency estimation, and other techniques may be used to process voiceprints. This generated voiceprint is then stored for future use.

At a later time, the user provides a voice input, e.g., speaks his name. The authenticator device 2 authenticates the user by comparing the user's real-time speech with the previously stored copy of the speaker's voiceprint to ensure that the acoustic and linguistic properties match. Where there are multiple authorized users, authenticator device 2 identifies the particular authorized user. In further embodiments, the user may first input his purported identity and then provide the voice input which is utilized to generate the response voiceprint.

FIG. 2 illustrates a simplified block diagram of the authenticator device 2 shown in FIG. 1 capable of performing user authentication (also referred to herein as user validation) utilizing voiceprint identification. Authenticator device 2 includes a donned and doffed detector 25 and a donned and doffed determination module 27. The authenticator device 2 includes a processor 10 operably coupled via an interconnect 26 to a data communications interface 12, memory 14, a microphone 20, a speaker 22, a user interface 24, donned and doffed detector 25 and donned and doffed determination module 27. In one example, data communications interface 12 is a wireless communications transceiver (e.g., utilizing Bluetooth communications) operable to receive an authentication request from the authentication requestor device 4.

There are various types of sensors and detectors which can be employed as donned and doffed detector 25 to determine whether the authenticator device 2 is donned or doffed. Techniques that can be used to determine whether the authenticator device 2 is donned or doffed include, but are not limited to, utilizing one or more of the following sensors and detectors integrated in the authenticator device 2 and/or disposed on or within one or more of the headphones of the authenticator device 2: a thermal or infrared sensor, skin resistivity sensor, capacitive touch sensor, inductive proximity sensor, magnetic sensor, piezoelectric-based sensor, and motion detector.

The output of donned and doffed detector 25 is provided to donned and doffed determination module 27 for determining whether the output corresponds to a donned state or a doffed state. Although illustrated separately, donned and doffed determination module 27 may be an application residing in memory 14.

Memory 14 stores a data structure 16 (e.g., a database, table, or any other file/memory structure) for storing user authentication data as described herein, and an authentication application 18 (e.g., including a voiceprint match application for comparing the voiceprint of user received speech to an authorized user voiceprint stored in data structure 16). Memory 14 may also include pre-stored audio prompts for output through the speaker 22 which prompt the user to speak his response to questions, his name, etc. Memory 14 may store donned and doffed determination module 27, output patterns from donned and doffed detector 25, and predetermined output profiles for comparison to determine the donned and doffed state of the authenticator device 2. Memory 14 may also include a speech recognition application for recognizing the content of user speech received at microphone 20.

Memory 14 may include a variety of memories, and in one example includes SDRAM, ROM, flash memory, or a combination thereof. Memory 14 may further include separate memory structures or a single integrated memory structure. In one example, memory 14 may be used to store passwords, network and telecommunications programs, and/or an operating system (OS).

Processor 10, using executable code and applications stored in memory, performs the necessary functions associated with user authentication and authenticator device operation described herein. Processor 10 allows for processing data, in particular managing data between detector 25, determination module 27, and memory 14 for determining the donned or doffed state of authenticator device 2, and determining whether the state of the authenticator device 2 has switched from being doffed to donned or vice versa. Processor 10 further processes user speech received at microphone 20 using authentication application 18. In one example, the authenticator device 2 continuously monitors the donned or doffed status of the authenticator device 2. In one embodiment, upon detection that the authenticator device 2 is in a newly donned status, the user authentication process begins. Upon detection of a doffed status, any prior user authentication is terminated.

In one example, processor 10 is a high performance, highly integrated, and highly flexible system-on-chip (SoC), including signal processing functionality such as echo cancellation/reduction and gain control in another example. Processor 10 may include a variety of processors (e.g., digital signal processors), with conventional CPUs being applicable. User interface 24 allows for user communication with the authenticator device 2, and in one example includes an audio and/or visual interface such that an audio prompt may be provided to the user's ear and/or an LED may be lit.

In further examples, authenticator device 2 may include additional biometric input devices for authenticating the identity of user 8. For example, authenticator device 2 may include a fingerprint scanner for scanning a user fingerprint or a retinal scanner for scanning a user retina.

In one example, memory 14 stores a user biometric data and an authentication application program 18. The authentication application 18 is configured to identify a donned condition of the authenticator device 2 from the detector 25 output, and authenticate an identity of the user 8. The identity of the user 8 is authenticated by comparing the user biometric data stored in the memory 14 and a current real-time biometric input at the authenticator device 2. If authentication is successful, an authenticated state is entered as long as the donned condition is successful. For example, the user biometric data is a voiceprint data and the current biometric input is a user speech received at the microphone 20. The authenticated state is maintained if the authenticator device 2 has not shifted from the donned condition to a doffed condition subsequent to authentication of the identity of the user 8.

The authentication application 18 receives authentication requests while the authenticator device 2 is in the authenticated state. The authentication application 18 reports an authentication success to the authentication requestor device 4 if the authenticator device 2 is in the authenticated state. In one example, the authenticated state was entered prior to receiving the request to authenticate the user 8 from the authentication requestor device 4. The authentication application 18 outputs at the speaker 22 an authentication success voice message at the speaker 22. The authentication application 18 terminates the authenticated state following identification from the detector output of a shift from the donned condition to a doffed condition.

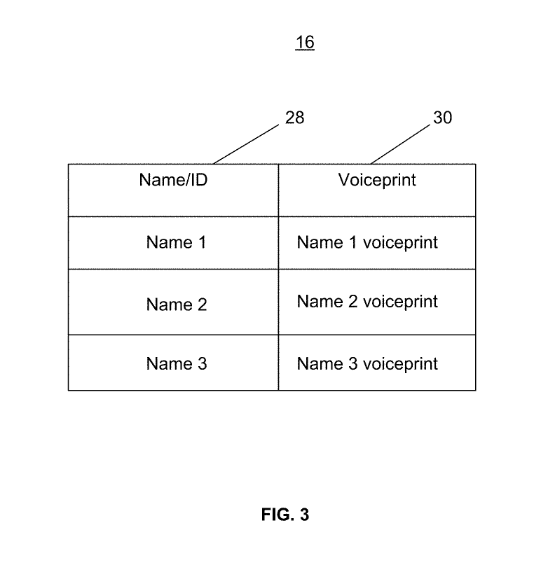

FIG. 3 illustrates a simplified illustration of a data structure 16 at the authenticator device 2 shown in FIG. 2 storing biometric authentication data. In this example, for each authorized user of the authenticator device 2, data structure 16 will store the authorized user name/ID 28 and corresponding voiceprint 30. In the example shown in FIG. 3, the authenticator device 2 authenticates the user by voiceprint matching.

During authentication of a user from a non-authenticated state, authenticator device 2 compares the user's real-time speech with the previously stored copy of the speaker's voiceprint 30 to ensure that the acoustic and linguistic properties match. In one embodiment, the user speaks his name and authenticator device identifies and authenticates the user utilizing the contents of data structure 16. In a further embodiment, the user speaks his name which is recognized as a name/ID 28 entry using speech recognition, and the authenticator device 2 prompts the user to then speak a phrase key. A voiceprint is generated from the user response and matched to the corresponding voiceprint 30 entry in the data structure 16 to authenticate the user.

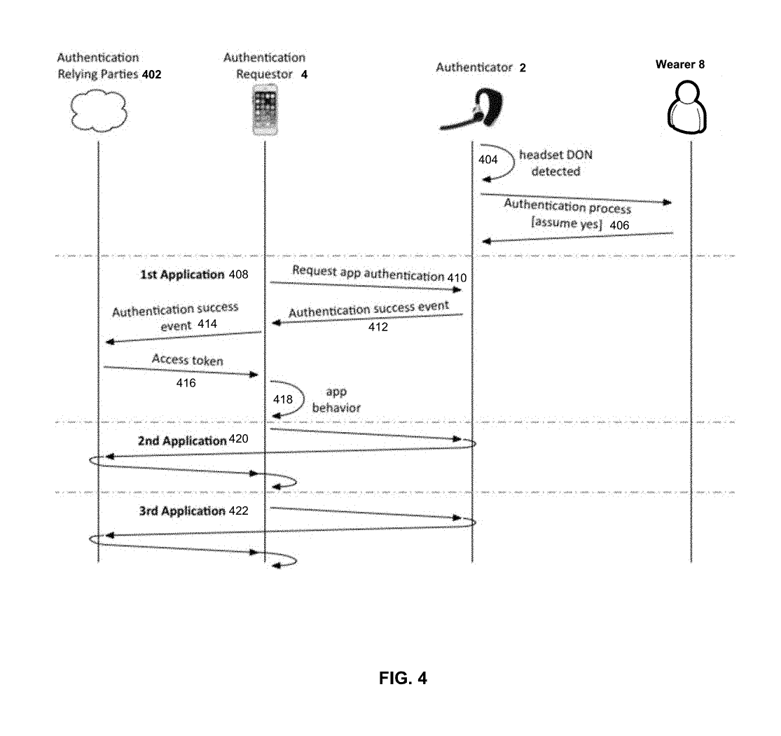

FIG. 4 illustrates a process for persistent user authentication in one example allowing a user 8 (e.g., a headset wearer) to access a secure system. At step 404, a shift to a headset donned state is detected. At step 406, authenticator device 2 authenticates the identity of wearer 8 (e.g., using a biometric verification). Assuming the wearer 8 is properly authenticated, authenticator device enters and persists in (i.e., maintains) an authenticated state until the user removes the authenticator device. Specifically, while persisting in the authenticated state, any requests received at the authenticator device 2 to authenticate the user will result in the authenticator device 2 reporting to the authentication requestor device 4 that the user is authenticated without the user needing to repeat the authentication process 406.

For example, at step 410, a first application 408 transmits a user authentication request to authenticator device 2. At step 412, authenticator device 2 reports an authentication success event to authentication requestor device 4 without the need to engage wearer 8 in the authentication process. At step 414, authentication requestor device 4 transmits an authentication success event to an authentication relying party 402. Responsive to the authentication success, at step 416, authentication relying party 402 transmits an access token to authentication requestor device 4, thereby granting/permitting app behavior at step 418. In a similar manner, second application 420 and third application 422 request user authentication at a later time and receive authentication success events without the need to engage wearer 8 in the authentication process as long as authenticator device 2 persists in the authenticated state.

In a further embodiment, the initial authentication process at step 406 requiring user engagement (i.e., user provides biometric input) is performed after receiving the first user authentication request from first application 408. Subsequent authentication requests by second application 420 and third application 422 are automatically approved as described above as long as the authenticator device 2 persists in the authenticated state.

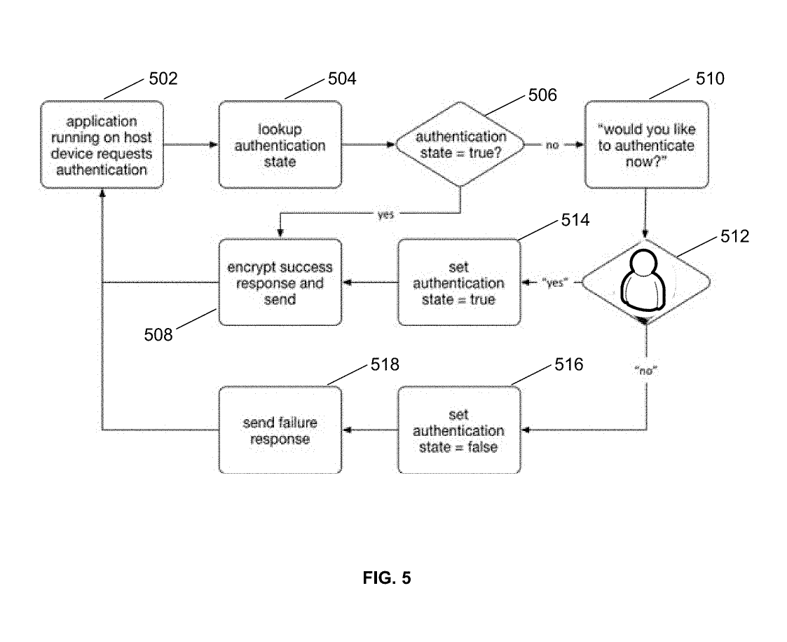

In various embodiments, the techniques of FIGS. 5, 6A-6C, 7A-7B, and 8 discussed below may be implemented as sequences of instructions executed by one or more electronic systems. In one embodiment, the instructions may be stored by the authenticator device 2 or the instructions may be received by the authenticator device 2 (e.g., via a network connection).

FIG. 5 is a flow diagram illustrating a process for persistent user authentication in a further example. At block 502, an application running on a host device requests user authentication. At block 504, the current user authentication state is determined (e.g., using a lookup instruction). At decision block 506, it is determined if the current user authenticated state is equal to true (i.e., the user is currently authenticated). If yes, at decision block 506, at block 508, an authentication success response is encrypted and sent. If no a decision block 506 (i.e., the user is not currently authenticated), at block 510 a prompt is output to the user asking if the user would like to authenticate and the user authentication process occurs. At decision block 512, it is determined whether the user authentication is successful. If yes, at block 514 the authentication state is set to true and the process proceeds to block 508 where an authentication success response is encrypted and sent. If no at decision block 512, at block 516 the authentication state is set to false. At block 518, an authentication failure response is sent.

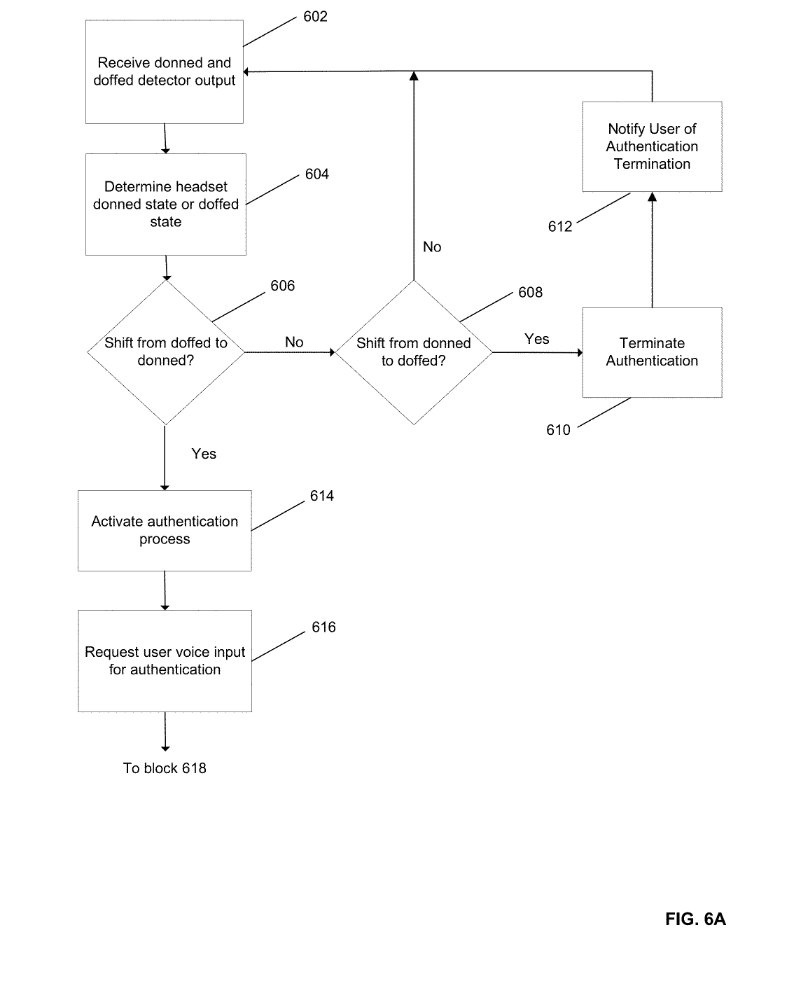

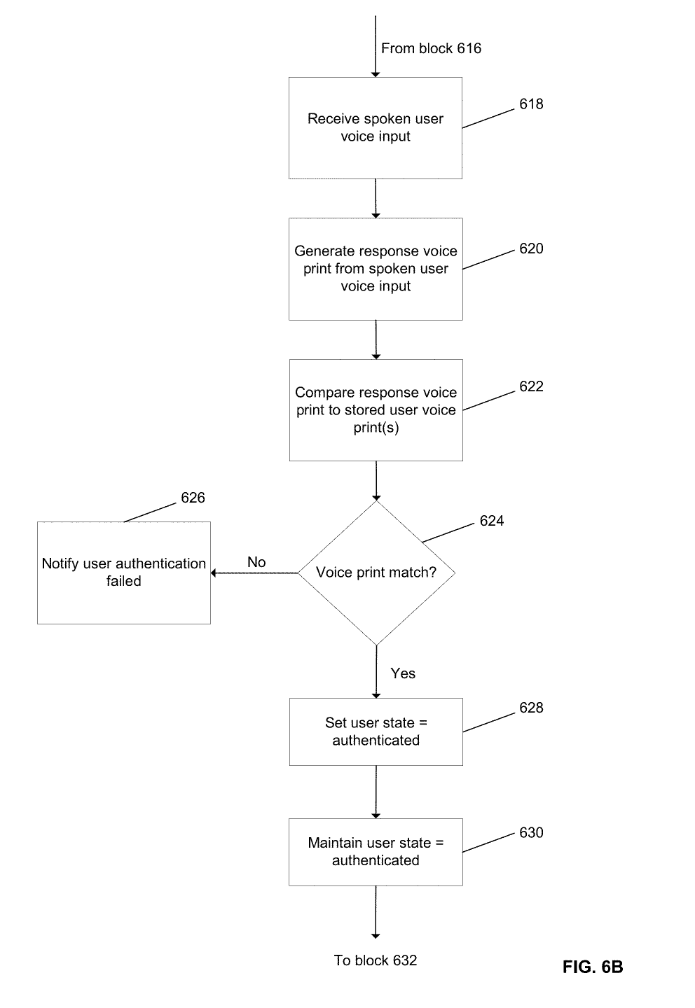

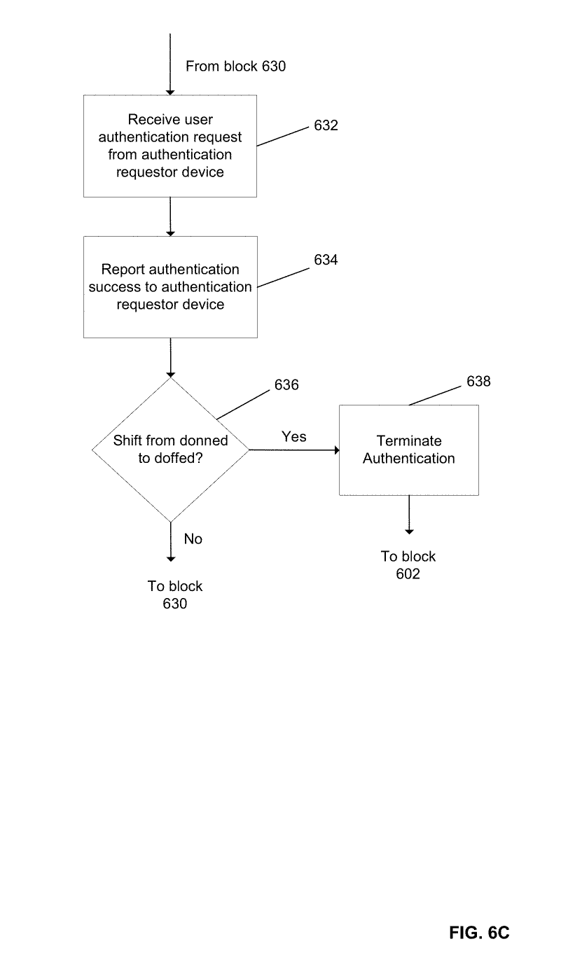

FIGS. 6A-6C are a flow diagram illustrating a process for user authentication in a further example. At block 602, an output from a donned and doffed detector is received. At block 604, an authenticator device (e.g., a headset) donned state or doffed state is determined. For example, the authenticator device compares the detector output to predetermined detector output profiles that reflected a donned state or a doffed state. The predetermined detector output profiles may be in look-up tables or a database and may include a variety of parameters based on the particular detector being used. Where the donned and doffed detector is a capacitive touch sensor, the measured capacitance relative to a threshold value is used to determine a donned or doffed state.

At decision block 606, it is determined whether there has been a shift from a doffed state to a donned state. If no at decision block 606, at decision block 608 it is determined whether there has been a shift from a donned state to a doffed state. If no at decision block 608, the process returns to block 602. If yes at decision block 608, at block 610 authentication of the user is terminated. At block 612, the user is notified of the authentication termination. The process then returns to block 602.

If yes at decision block 606, at block 614 the authentication process is activated. At block 616, a user voice input for authentication is requested. At block 618, the user spoken voice input is received. At block 620, a response voiceprint is generated from the spoken user voice input. At block 622, the response voiceprint is compared to stored user voiceprint(s).

At decision block 624, it is determined whether there is a voiceprint match between the spoken response voiceprint and the stored user voiceprint(s). If no at decision block 624, then at block 626 the user is notified of the authentication failure. If yes at decision block 624, at block 628 the user state=authenticated status is set. At block 630 the user state=authenticated status is maintained.

At block 632, a user authentication request is received from an authentication requestor device. At block 634, an authentication success or equivalent is reported (i.e., sent) to the authentication requestor device. At decision block 636, it is determined whether there has been a shifted from a donned state to a doffed state. If yes at decision block 636, at block 638 authentication is terminated and the process returns to block 602. If no at decision block 636, the process returns to block 630 and the user authenticated state is maintained.

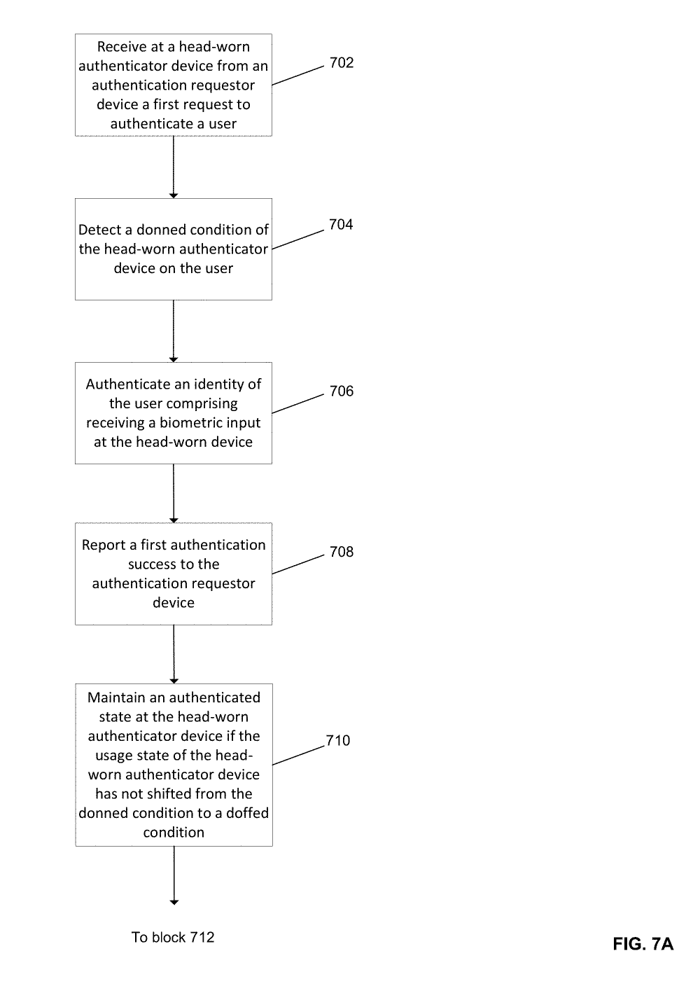

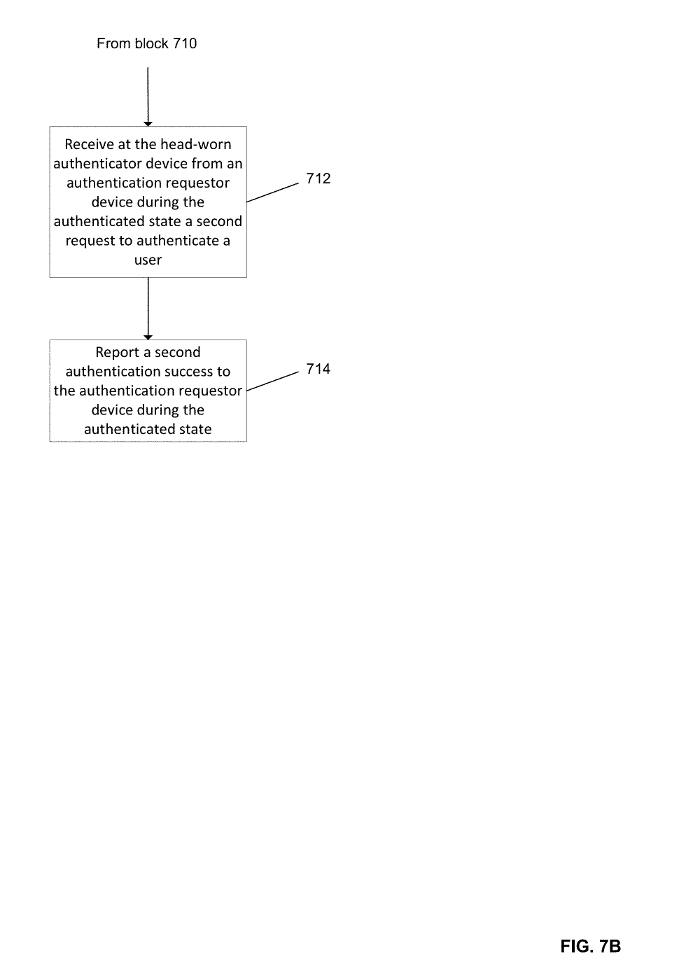

FIGS. 7A and 7B are a flow diagram illustrating a process for user authentication in a further example. At block 702, a first request to authenticate a user is received at a head-worn authenticator device from an authentication requestor device. In one example, the head-worn authenticator device is a Bluetooth headset and the authentication requestor device is a smartphone.

At block 704, a donned condition of the head-worn authenticator device is detected on the user. In one example, detecting the donned condition of the head-worn authenticator device on the user is performed by identifying a shift from a doffed condition to the donned condition. At block 706, an identity of the user is authenticated by receiving a biometric input at the head-worn device. For example, to authenticate the user, a user voice input is received and a current user voiceprint is generated from the user voice input. The user is authenticated by matching the current user voiceprint to a prior voiceprint stored on the head-worn device.

At block 708, a first authentication success is reported to the authentication requestor device. An authentication success voice message is output at a speaker of the head-worn authenticator device following authenticating the identity of the user. At block 710, an authenticated state is maintained at the head-worn authenticator device if the usage state of the head-worn authenticator device has not shifted from the donned condition to a doffed condition subsequent to detecting the donned condition of the head-worn authenticator device on the user.

At block 712, a second request to authenticate a user is received at the head-worn authenticator device from an authentication requestor device during the authenticated state. At block 714, a second authentication success is reported to the authentication requestor device during the authenticated state. The process further includes identifying a shift from the donned condition to a doffed condition and responsively terminating the authenticated state of the head-worn authentication device.

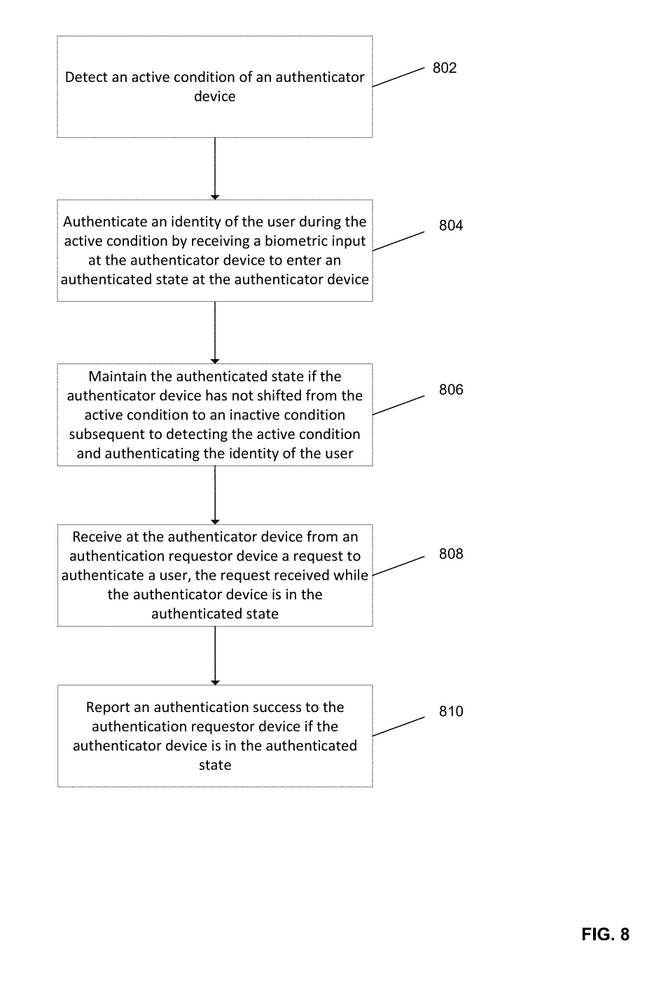

FIG. 8 is a flow diagram illustrating a process for user authentication in a further example. At block 802, an active condition of an authenticator device is detected. In one example, the authenticator device is a head-worn device and the active condition is a donned condition on a user head and the inactive condition is a doffed condition off the user head. In one example, the authenticator device is a computing device and the active condition is a carried condition and the inactive condition is a not carried condition. In one example, the active condition is a normal usage of the authenticator device and the inactive condition is any non-usage or usage falling outside of normal usage of the authenticator device.

At block 804, an identity of the user is authenticated during the active condition. For example, the user identity is authenticated by receiving a biometric input at the authenticator device to enter an authenticated state at the authenticator device. In one example, authenticating an identity of the user is performed by receiving a user voice input, generating a current user voiceprint from the user voice input, and matching the current user voiceprint to a prior voiceprint stored on the authenticator device. In one example, the process further includes outputting an authentication success message at the authenticator device following authenticating the identity of the user.

At block 806, the authenticated state is maintained if the authenticator device has not shifted from the active condition to an inactive condition subsequent to detecting the active condition and authenticating the identity of the user. At block 808, a request to authenticate a user is received at the authenticator device from an authentication requestor device. The request is received while the authenticator device is in the authenticated state.

At block 810, an authentication success is reported from the authenticator device to the authentication requestor device if the authenticator device is in the authenticated state. The authenticated state was entered following authenticating the identity of the user prior to receiving the request to authenticate the user from the authentication requestor device. In one example, the process further includes identifying a shift from the active condition to an inactive condition and responsively terminating the authenticated state of the authenticator device.

While the exemplary embodiments of the present invention are described and illustrated herein, it will be appreciated that they are merely illustrative and that modifications can be made to these embodiments without departing from the spirit and scope of the invention. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. A method for authenticating an identity of a user comprising:
detecting an active condition of an authenticator device;
authenticating an identity of the user during the active condition comprising receiving a biometric input at the authenticator device to enter an authenticated state at the authenticator device;
maintaining the authenticated state if the authenticator device has not shifted from the active condition to an inactive condition subsequent to authenticating the identity of the user;
receiving at the authenticator device from an authentication requestor device a request to authenticate a user, the request received while the authenticator device is in the authenticated state; and
reporting an authentication success to the authentication requestor device if the authenticator device is in the authenticated state, the authenticated state entered following authenticating the identity of the user prior to receiving the request to authenticate the user from the authentication requestor device.

2. The method of claim 1, wherein the authenticator device is a head-worn device and the active condition comprises a donned condition on a user head and the inactive condition comprises a doffed condition off the user head.

3. The method of claim 1, wherein the authenticator device is a computing device and the active condition comprises a carried condition and the inactive condition comprises a not carried condition.

4. The method of claim 1, wherein the active condition comprises a normal usage of the authenticator device and the inactive condition comprises non-usage of the authenticator device.

5. The method of claim 1, further comprising outputting an authentication success message at the authenticator device following authenticating the identity of the user.

6. The method of claim 1, wherein the authenticator device comprises a Bluetooth headset and the authentication requestor device comprises a smartphone.

7. The method of claim 1, wherein authenticating the identity of the user comprises:
receiving a user voice input;
generating a current user voiceprint from the user voice input; and
matching the current user voiceprint to a prior voiceprint stored on the authenticator device.

8. The method of claim 1, further comprising identifying a shift from the active condition to an inactive condition and responsively terminating the authenticated state of the authenticator device.

9. The method of claim 1, wherein the authentication requestor device is a computing device.

10. A method for authenticating an identity of a user comprising:
receiving at a head-worn authenticator device from an authentication requestor device a first request to authenticate a user;
detecting a donned condition of the head-worn authenticator device on the user;
authenticating an identity of the user comprising receiving a biometric input at the head-worn authenticator device;
reporting a first authentication success to the authentication requestor device;
maintaining an authenticated state at the head-worn authenticator device if a usage state of the head-worn authenticator device has not shifted from the donned condition to a doffed condition subsequent to detecting the donned condition of the head-worn authenticator device on the user;
receiving at the head-worn authenticator device from an authentication requestor device during the authenticated state a second request to authenticate a user; and
reporting a second authentication success to the authentication requestor device during the authenticated state.

11. The method of claim 10, wherein detecting the donned condition of the head-worn authenticator device on the user comprises identifying a shift from a doffed condition to the donned condition.

12. The method of claim 10, further comprising outputting an authentication success voice message at a speaker of the head-worn authenticator device following authenticating the identity of the user.

13. The method of claim 10, wherein the head-worn authenticator device comprises a Bluetooth headset and the authentication requestor device comprises a smartphone.

14. The method of claim 10, wherein authenticating the identity of the user comprising receiving the biometric input at the head-worn authenticator device comprises:
receiving a user voice input; and
generating a current user voiceprint from the user voice input; and
matching the current user voiceprint to a prior voiceprint stored on the head-worn authenticator device.

15. The method of claim 10, further comprising identifying a shift from the donned condition to a doffed condition and responsively terminating the authenticated state of the head-worn authenticator device.

16. A head-worn authenticator device comprising:
a detector providing a detector output indicating a donned condition or doffed condition;
a microphone;
a speaker;
a wireless communications transceiver operable to receive an authentication request from an authentication requestor device;
a processor; and
a memory comprising:
a user biometric data; and
an application program comprising executable instructions to:
identify a donned condition of the head-worn authenticator device from the detector output;
authenticate an identity of the user utilizing the user biometric data stored in the memory and a current biometric input at the head-worn authenticator device to enter an authenticated state during the donned condition;
maintain the authenticated state if the head-worn authenticator device has not shifted from the donned condition to a doffed condition subsequent to authentication of the identity of the user;
receive the authentication request to authenticate a user, the authentication request received while the head-worn authenticator device is in the authenticated state; and
report an authentication success to the authentication requestor device utilizing the wireless communications transceiver if the head-worn authenticator device is in the authenticated state, the authenticated state entered prior to receiving the authentication request to authenticate the user from the authentication requestor device.

17. The head-worn authenticator device of claim 16, wherein the user biometric data is a voiceprint data and the current biometric input is a user speech received at the microphone.

18. The head-worn authenticator device of claim 16, wherein the application program further comprises executable instructions to output at the speaker an authentication success voice message at the speaker following authenticating the identity of the user.

19. The head-worn authenticator device of claim 16, wherein the wireless communications transceiver comprises a Bluetooth communications transceiver.

20. The head-worn authenticator device of claim 16, wherein the authentication requestor device is a smartphone.

21. The head-worn authenticator device of claim 16, wherein the application program further comprises executable instructions to terminate the authenticated state following identification from the detector output of a shift from the donned condition to a doffed condition.
